(19) United States
(12) Patent Application Publication
(10) Pub. No.: US 2006/0203813 A1
(43) Pub. Date: Sep. 14, 2006

(54) SYSTEM AND METHOD FOR MANAGING A MAIN MEMORY OF A NETWORK SERVER

(76) Inventor: Cheng-Meng Wu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,200

(22) Filed: Dec. 19, 2005

(30) Foreign Application Priority Data
Dec. 24, 2004 (TW) 093140441

(51) Int. Cl. H04L 12/50

(52) U.S. Cl. 370/363

(57) ABSTRACT

A computerized method for managing a main memory of a network server includes the steps of: (a) constructing a plurality of data structures according to data received by the server (1) from the client computers (2); (b) setting the data structures into a queue; (c) determining whether a function in a dynamic link library (DLL) (113) needs to be executed according to the data structures; (d) executing a network serving program (111) to process the data structures and generating processed results, if no function in the DLL needs not to be executed; and (e) executing a function serving program (112) to process the data structures and generating execution results, if any function in the DLL needs to be executed. A related system is also disclosed.

### FIELD OF THE INVENTION

The present invention generally relates to systems and methods for managing a storage, and more particularly to a system and method for managing a main memory of a network server.

### DESCRIPTION OF RELATED ART

Network servers are often used to process data in a network system. Among the functions, the network servers perform the transformation of a data packet into a network format that allows the data packet to be transmitted across a network. Typically, a network server having a multithreading processor can simultaneously serve numerous data packets. The numerous data packets have different data structures from one another. Occasionally, the numerous data packets are so large that a single thread may delay the processing of subsequent threads. To prevent such a delay, the multithreading processor periodically allocates different memory spaces to perform the subsequent threads.

In some instances, it is desirable to construct network systems with a plurality of nodes (i.e. workstations, personal computers, or servers). Each node having a plurality of data packets shares memory spaces of the network servers. Therefore, it is possible for an application of the nodes spanning a large number of subsequent threads to participate in a main memory of the network server. For overall usability, such an operating system (such as a Windows, or a Linux) typically provides a mechanism for managing each node correctly accessing the main memory of the network server.

What is needed, therefore, is a system for managing a main memory of a network server, which can manage each node to correctly access the main memory, decrease demands of memory spaces, and increase number of nodes connected to the network server.

Similarly, what is also needed is a method for managing a network memory of a server, which can manage each node to correctly access the main memory, decrease demands of memory spaces, and increase number of nodes connected to the network server.

### SUMMARY OF INVENTION

A system for managing a main memory of a network server in accordance with a preferred embodiment includes a server connected to a plurality of client computers via a network. The server includes a central processing unit (CPU), a storage and a main memory divided into a plurality of data blocks. The data blocks comprise a management block, a network serving block, a function serving block, and a dynamic link library (DLL) private block.

The management block that provides a first memory space for executing a management program which is used for constructing a plurality of data structures according to data received by the server, setting the data structures into a queue, and determines whether a function in a DLL needs to be executed according to the data. The network serving block that provides a second memory space for executing a network serving program which is used for generating a plurality of network serving threads to obtain the data structures from the queue, processing the data of the data structures, and generating processed results according to the data. The function serving block that provides a third memory space for executing a function serving program which is used for generating a plurality of function serving threads to obtain the data structures from the queue, executing the functions of the DLL to process the data of the data structures, and generating execution results according to the data. The DLL private block that provides a forth memory space for storing the DLL which includes a plurality of functions executable by the function serving program.

Another preferred embodiment provides a computerized method for managing a main memory of a network server by utilizing the above system. The method comprises the steps of: (a) constructing a plurality of data structures according to data received by the server from the client computers; (b) setting the data structures into a queue; (c) determining whether a function in a dynamic link library (DLL) needs to be executed according to the data structures; (d) executing a network serving program to process the data structures and generating processed results, if no function in the DLL needs not to be executed; and (e) executing a function serving program to process the data structures and generating execution results, if any function in the DLL needs to be executed.

Wherein the step (d) comprises the steps of: (d1) loading the network serving program to a main memory of the server; (d2) generating a plurality of network serving threads to process the data structures; (d3) obtaining one of the data structures from the queue when a network serving thread has been activated; and (d4) processing the data of the data structure by the network serving thread.

Wherein the step (e) comprises the steps of: (e1) loading the function serving program to the main memory of the server; (e2) loading a DLL to the main memory of the server; (e3) generating a plurality of function serving threads to process the data structures; (e4) obtaining one of the data structures from the queue when a function serving thread has been activated; and (e5) executing corresponding functions by means of linking the DLL to process the data of the data structure.

Other advantages and novel features of the embodiments will be drawn from the following detailed description with reference to the attached drawings, in which:

### BRIEF DESCRIPTION OF DRAWINGS

FIG. 1 is a schematic diagram of a computer system for managing a main memory of a network server according to a preferred embodiment;

FIG. 2 is a schematic diagram of configuration of a storage and a main memory of a server of FIG. 1;

FIG. 3 is a schematic diagram of data flow between programs of the storage of FIG. 2;

FIG. 4 is a flowchart of a preferred method for managing a main memory of a network server by utilizing the system of FIG. 1;

FIG. 5 is a detailed description of one step of FIG. 4, namely executing the network serving program to process the data received from the client computers; and

FIG. 6 is a detailed description of another step of FIG. 4, namely executing the function serving program to process the data received from the client computers.

### DETAILED DESCRIPTION

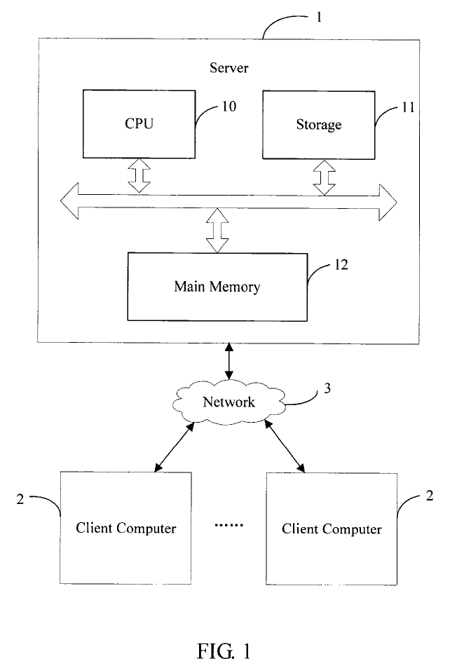

FIG. 1 is a schematic diagram of a computer system for managing a main memory of a network server (hereinafter, “the system”) according to a preferred embodiment. The system includes a server 1, a plurality of client computers 2 (only two shown) and a network 3. The server 1 is used for receiving data to be processed from the client computers 2, and sending processed results to the client computers 2. The server 1 generally includes a central processing unit (CPU) 10, a storage 11 and a maim memory 12. The client computers 2 are connected to the server 1 via the network 3. Each of the client computers 2 sends data to the server 1, and receives processed results from the server 1. The network 3 may be an intranet, the Internet, or any other suitable communications network.

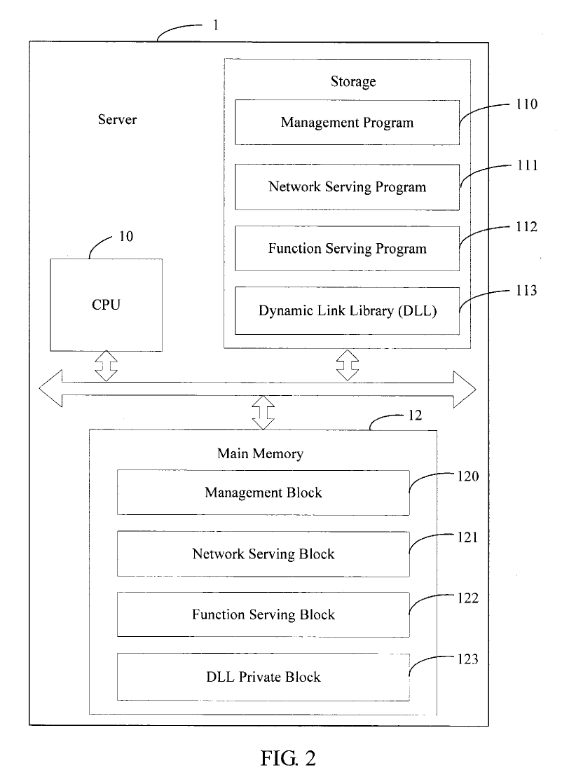

FIG. 2 is a schematic diagram of configuration of the storage 11 and the main memory 12. The storage 11 is typically an accessory memory (i.e. a hard disk) connected to the main memory 12, which stores a management program 110, a network serving program 111, a function serving program 112, and a dynamic link library (DLL) 113 having a plurality of functions. The main memory 12 can be divided into a plurality of data blocks, which include a management block 120, a network serving block 121, a function serving block 122, and a DLL private block 123.

The management program 110 is used for constructing a plurality of data structures according to data received by the server 1, setting the data structures into a queue to wait for being processed by the network serving program 111 or the function serving program 112, and determining whether a function in the DLL 113 needs to be executed according to the data. The network serving program 111 is used for generating a plurality of network serving threads to obtain the data structures from the queue, processing the data of the data structures, and generating processed results. The function serving program 112 is used for generating a plurality of function serving threads to obtain the data structures from the queue, executing one or more functions in the DLL 113 to process the data of the data structures, and generating execution results. Each data structure stores temporarily the data and corresponding parameters of the functions to be executed by the function serving threads of the function serving program 112.

The management block 120 provides a first memory space for executing the management program 110. The network serving block 121 provides a second memory space for executing the network serving program 111. The function serving block 122 provides a third memory space for executing the function serving program 112. The DLL private block 123 provides a forth memory space for storing a dynamic link library having a plurality of functions which can be executed by the function serving program 112.

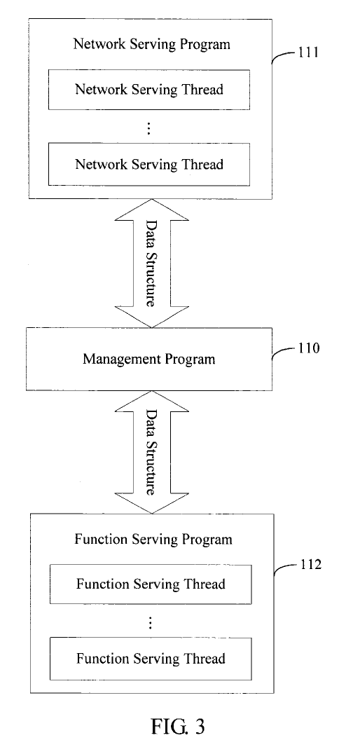

FIG. 3 is a schematic diagram of data flow between programs of the storage 11. When the server 1 receives requests for processing data from one or more of the client computers 2, the management program 110 constructs one or more data structures according to the received data, and sets the data structures into a queue to wait for being processed by the network serving program 111 or the function serving program 112. Then, the management program 110 determines whether a function in the DLL 113 needs to be executed according to the data structures. If no function in the DLL 113 needs to be executed, the network serving program 111 generates one or more network serving threads to obtain the data structures from the queue, processes the data of the data structures, and generates processed results. Otherwise, if any function in the DLL 113 needs to be executed, the function serving program 112 generates one or more function serving threads to obtain the data structures from the queue, processes the data of the data structure by means of executing the function in the DLL 113, and generates execution results.

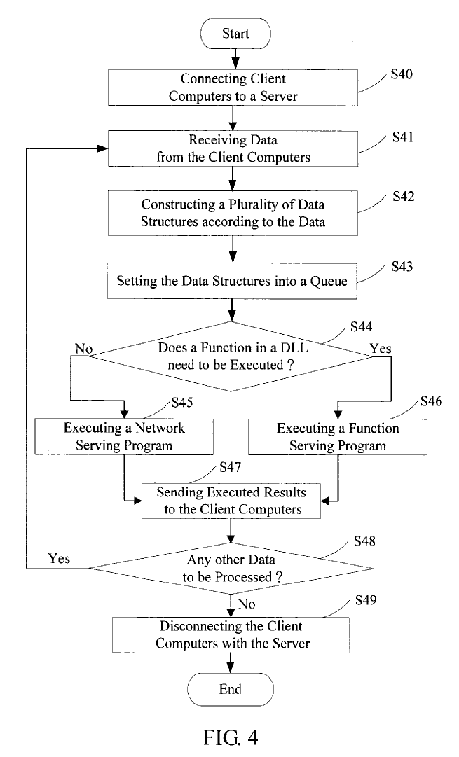

FIG. 4 is a flowchart of a preferred method for managing a main memory of a network server by utilizing the system of FIG. 1. In step S40, the management program 110 connects one or more client computers 2 whose data need to be processed to the server 1. In step S41, the client computers 2 send respective data to the server 1. In step S42, the management program 110 constructs a data structure for data from each client computer 2, and writes the data and corresponding parameters into the data structure. In step S43, the management program 110 sets all the data structures into a queue, in order to wait for being processed by the network serving program 111 or the function serving program 112. In step S44, the management program 110 determines whether a function in the DLL 113 needs to be executed according to the data structures. If no function in the DLL 113 needs to be executed, in step S45, the CPU 10 executes the network serving program 111 to process the data of the data structures, and generate processed results. Otherwise, if any function in the DLL 113 needs to be executed, in step S46, the CPU 10 executes the function serving program 112 to process the data of the data structures and generates execution results. In step S47, the server 1 sends the processed results or the execution results to the client computers 2 via the network 3. In step S48, the server 1 determines whether any other data need to be processed by the server 1. If there are other data to be processed by the server 1, the procedure returns to step S41 described above. Otherwise, if no data need to be processed by the server 1, in step S49, the management program 110 disconnects the server 1 with the client computers 2.

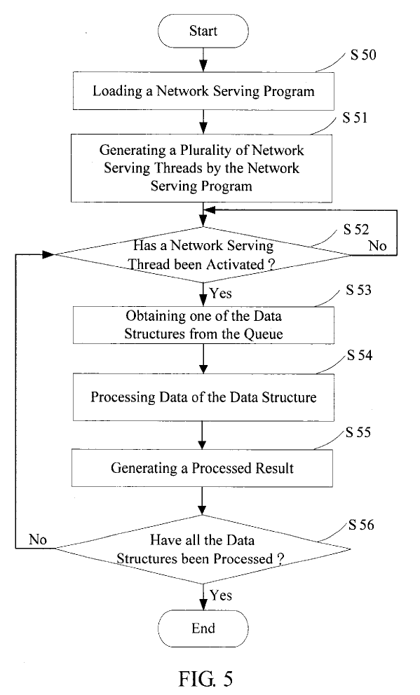

FIG. 5 is a detailed description of step S45 of FIG. 4, namely executing the network serving program 111 to process the data received from the client computers 2. In step S50, the CPU 10 loads the network serving program 111 to the network serving block 121 of the main memory 12. In step S51, the network serving program 111 generates a plurality of network serving threads in order to process the data structures in the queue respectively. In step S52, the CPU 10 determines whether a network serving thread has been activated. If no network serving thread has been activated, the procedure returns to step S52 described above. Otherwise, if any network serving thread has been activated, in step S53, the network serving thread obtains a corresponding data structure from the queue. In step S54, the network serving thread processes the data of the data structure. In step S55, the network serving thread generates a processed result. In step S56, the CPU 10 determines whether all the data structures in the queue have been processed. If there are data structures in the queue to be processed, the procedure returns to step S52 described above. Otherwise, if all the data structures in the queue have been processed, the procedure is finished.

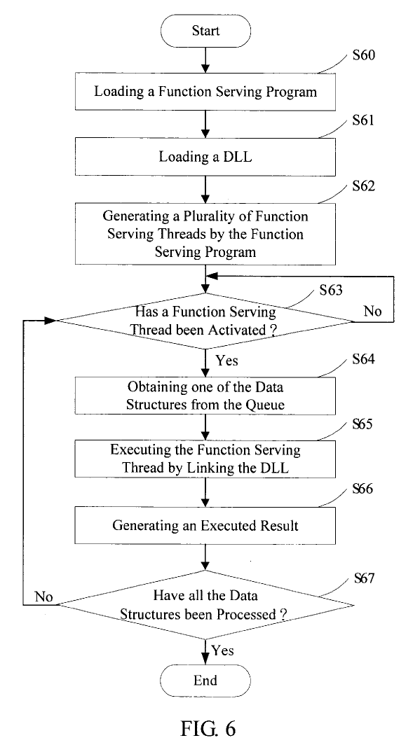

FIG. 6 is a detailed description of step S46 of FIG. 4, namely executing the function serving program 112 to process the data received from the client computers 2. In step S60, the CPU 10 loads the function serving program 112 to the function serving block 122 of the main memory 12. In step S61, the CPU 10 loads the DLL 113 to the DLL block 123 of the main memory 12. In step S62, the function serving program 112 generates a plurality of function serving threads in order to process the data structures in the queue. In step S63, the CPU 10 determines whether a function serving thread has been activated. If no function serving thread has been activated, the procedure returns to step S63 described above. Otherwise, if any function serving thread has been activated, in step S64, the function serving thread obtains a corresponding data structure from the queue. In step S65, the function serving thread executes a corresponding function by means of linking the DLL 113 to process the data of the data structure. In step S66, the function serving thread generates an execution result. In step S67, the CPU 10 determines whether all the data structures in the queue have been processed. If there are data structures in the queue to be processed, the procedure returns to step S63 described above. Otherwise, if all the data structures in the queue have been processed, the procedure is finished.

According to the above-described system and method, the following describes an example of allocating memory spaces for programs to process data from one hundred client computers 2 simultaneously. The server 1 receives the data from the client computers 2, and the management program 110 determines whether any function in the DLL 113 needs to be executed according to the received data.

If no function in the DLL 113 needs to be executed, the CPU 10 executes the network serving program 111 to process the data. The server 1 needs one hundred network serving threads generated by the network serving program 111 to process the data from the one hundred client computers 2. Because a network serving block 121 is allocated to each network serving thread, the server 1 allocates one management block 120 to the management program 110, and one hundred network serving blocks 121 to the network serving threads generated by the network serving program 111. It is assumed that each data block has a memory space of 400 KB. Therefore, the total memory space of the main memory 12 to be allocated to the client computers 2 is (1*400+100*400) KB.

Otherwise, if a function in the DLL 113 needs to be executed, the CPU 10 executes the function serving program 112 to process the data. The server 1 needs one hundred function serving threads generated by the function serving program 112 to process the data from the one hundred client computers 2, and needs one DLL 113. Then, the server 1 allocates one management block 120 to the management program 110, one hundred function serving blocks 122 to the function serving threads, and one DLL block 123 to the DLL 113. Therefore, the total memory space of the main memory 12 to be allocated to the client computers 2 is (1*400+100*400+1*400) KB.

According to the above-described memory space allocating mechanism, the total memory space of the main memory 12 to be allocated to the client computers 2 is (1*400+100*400+) KB or (1*400+100*400+1*400) KB. However, by utilizing the traditional method sated above, the total memory space of the main memory 12 to be allocated to the client computers 2 is (100*400+100*400) KB. Therefore, the memory space used by the present method is much less than the memory space used by the traditional method.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for managing a main memory of a network server, the system comprising a server connected to a plurality of client computers via a network, the server comprising a central processing unit (CPU), a storage and a main memory which can be divided into a plurality of data blocks, the plurality of data blocks comprising:
a management block that provides a first memory space for executing a management program which is used for constructing a plurality of data structures according to data received by the server, setting the data structures into a queue, and determines whether a function in a dynamic link library (DLL) needs to be executed according to the data;
a network serving block that provides a second memory space for executing a network serving program which is used for generating a plurality of network serving threads to obtain the data structures from the queue, processing the data of the data structures, and generating processed results according to the data; and
a function serving block that provides a third memory space for executing a function serving program which is used for generating a plurality of function serving threads to obtain the data structures from the queue, executing functions in the DLL to process the data of the data structures, and generating execution results according to the data.

2. The system according to claim 1, wherein the plurality of data blocks further comprise a DLL private block that provides a forth memory space for storing the DLL which comprises a plurality of functions executable by the function serving program.

3. The system according to claim 1, wherein the network serving program generates a network serving thread for each client computer to process the data from the client computer.

4. The system according to claim 1, wherein the function serving program generates a function serving thread for each client computer to process the data from the client computer.

5. A computerized method for managing a main memory of a server, the server being connected to a plurality of client computers via a network, the method comprising the steps of:
constructing a plurality of data structures according to data received by the server from the client computers;
setting the data structures into a queue;
determining whether a function in a dynamic link library (DLL) needs to be executed according to the data structures;
executing a network serving program to process the data structures and generating processed results, if no function in the DLL needs not to be executed; and
executing a function serving program to process the data structures and generating execution results, if any function in the DLL needs to be executed.

6. The method according to claim 5, wherein the queue is used for storing various data structures for being processed by the network serving program or by the function serving program.

7. The method according to claim 5, wherein the step of executing the network serving program comprises the steps of:
loading the network serving program to a main memory of the server;
generating a plurality of network serving threads to process the data structures;
obtaining one of the data structures from the queue when a network serving thread has been activated; and
processing the data of the data structure by the network serving thread.

8. The method according to claim 5, wherein the step of executing the function serving program comprises the steps of:
loading the function serving program to a main memory of the server;
loading a DLL to the main memory;
generating a plurality of function serving threads to process the data structures;
obtaining one of the data structures from the queue when a function serving thread has been activated; and
executing corresponding functions by means of linking the DLL to process the data of the data structure.

9. The method according to claim 5, further comprising the step of:
disconnecting the client computers to the server, if no data are to be processed by the server.
